(19) United States
(12) Patent Application Publication
(10) Pub. No.: US 2011/0156886 A1
(43) Pub. Date: Jun. 30, 2011

(54) PAGING INTERFACE ADAPTER

(76) Inventors: William L. Clinkscales, Lake Worth, FL (US); Reeder Ward, Melbourne, FL (US)

(21) Appl. No.: 12/792,786

(22) Filed: Jun. 3, 2010

Related U.S. Application Data
(60) Provisional application No. 61/291,719, filed on Dec. 31, 2009.

(51) Int. Cl. G08B 5/22

(52) U.S. Cl. 340/286.07

(57) ABSTRACT

A system for interfacing between medical devices using different output protocols and medical personnel is provided. A user may configure the system to accept different external device outputs on different input ports of the system. The system may be programmed to correctly associate the input signals with alert conditions based upon the particular input device connected to the particular input port. The system may also be configured to send status information from the input devices to medical personnel by transmitting a message utilizing the output protocol appropriate to the communication system used by the medical personnel requiring the information.

### CROSS REFERENCE TO RELATED APPLICATIONS

This application claims the benefit of provisional patent application Ser. No. 61/291,719, filed with the USPTO on Dec. 31, 2009, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to paging systems, more specifically, the present invention relates to a Paging Interface Adapter (alternatively referred to herein as “the invention”) that is suited for receiving alarm and other signals from a variety of input sources, and sending information via a paging system to a paging receiver (pager). One use of such systems is to provide nurse call information and alerts to personal pagers, PDAs, cellular telephones, or other wireless communication devices used by hospital medical personnel, such that alarm and other information can be communicated via a wireless system to allow a timely response to calls for medical assistance by a caregiver.

The present disclosure relates to systems that monitor equipment and/or patients in hospital rooms and that alert caregivers to alarm conditions. More particularly, the present disclosure relates to systems that monitor equipment, such as hospital beds and patient call buttons, and that communicate via a network of a healthcare facility with computers at nurse call stations and with caregivers carrying one or more communication devices

2. Background Art

The use of paging systems for communicating alert and call information to medical care givers is known in the art.

Equipment in hospitals and other healthcare facilities sometimes communicates the status of the equipment via a network to a computer located at a nurse station or other location in the facility. If an alarm condition is detected, some sort of notification of the condition causing the alarm is shown on the display screen of the computer. See, for example, the network disclosed in U.S. Pat. No. 5,319,363 in which a number of different patient care devices provide information to a workstation at a nurse's station. Hospital beds are one example of equipment that sometimes communicate information via a network to a computer at a nurse's station. See, for example, U.S. Pat. Nos. 5,561,412 and 5,699,038. Caregivers sometimes wear or carry badges that communicate wirelessly with the network of the healthcare facility. Information from the badges, and from receivers with which the badges communicate, sometimes is used to determine the location of caregivers in the healthcare facility. Some caregivers may carry other wireless communication devices, such as pagers, wireless telephone handsets, personal digital assistants (PDA's), and other types of voice communication devices.

After a nurse at the master nurse's station sees that an alarm condition exists, the nurse may contact another caregiver assigned to a patient associated with the alarm condition so that the contacted caregiver can attend to the alarm condition. Thus, such systems require one person to take action to contact another person to attend to the alarm condition. The nurse at the master nurse's station may sometimes contact caregivers about alarm conditions that are not of consequence to the care of the associated patient and about which the contacted caregiver would prefer not to have been notified. U.S. Pat. No. 5,319,355 discloses a system in which alarm conditions detected by various pieces of equipment are transmitted to a master alarm control which then automatically communicates information about all received alarm conditions to pagers carried by designated caregivers, unless an operator at the master alarm interrupts the transmission of an alarm after it is received at the master alarm control. In such a system, the pieces of equipment at disparate locations determine their own alarm conditions and when an alarm condition occurs, the assigned caregivers are notified via their pagers. Thus, the caregivers may be paged about alarm conditions that do not require the attention of the caregiver. Receiving undesired notifications of alarm conditions may reduce the productivity of caregivers.

Furthermore, a significant problem arises when a medical care facility has, over the course of time, implemented various nurse call or equivalent systems such that the facility has a plurality of such systems simultaneously deployed. These systems are not generally interoperable. Such facilities may thus face ever increasing support and maintenance costs as they continue to keep the various systems deployed and operable; and, importantly, upgrades to the nurse call system may require the costly complete replacement of one legacy system in favor of another.

For instance, a number of legacy systems exist under the trade names AiPhone, Cornell, Dukane, Engineered Electronics, Heritage MedCall, and Tektone, among others. Each of these legacy systems utilizes signaling characteristics that may be distinct from the others for the alarm contact interface. Such signaling characteristics may take the form of “dry” contact, high-voltage contact, low-voltage contact, or pulsed alarm inputs. Alarm inputs are therefore not generally interoperable with nurse call systems from the various industry manufacturers.

It is thus desirable, and not currently known in the art, that an apparatus and method be provided for the purpose of allowing interoperability of a plurality of incompatible nurse call or equivalent systems so as to overcome the aforementioned problems with the current and prior art. It is further desirable that the apparatus and method provide a menu-driven approach for determining which particular legacy systems are providing inputs, so that the user of the system is not required to know specific signal characteristics of each legacy (or host) system providing input information to the apparatus and method.

### BRIEF SUMMARY OF THE INVENTION

In accordance with one embodiment, a system for interfacing patient status information with different paging protocols comprising an input bank further comprising at least one input port capable of receiving input data formatted in one of at least two different input protocols, at least one processor comprising an interpretation module and an I/O configuration module, wherein the input data is received by the interpretation module and translated into medical status, a user interface wherein the user interface selects the parameters of the I/O configuration module, and an output signal wherein the medical status is formatted by the processer and transmitted as an output signal in an output protocol determined by the parameter of the I/O configuration module is provided.

### BRIEF DESCRIPTION OF THE DRAWINGS

A better understanding of the present invention will be realized from the detailed description that follows, taken in conjunction with the accompanying drawings, in which:

FIG. 1 depicts a block diagram of the system.

FIG. 2 depicts another block diagram of the system.

FIG. 3 depicts yet another block diagram of the system.

FIG. 4 depicts one possible pulsed input waveform.

FIG. 5 depicts one possible pulsed input waveform.

FIG. 6 depicts one possible pulsed input waveform.

FIG. 7 depicts one possible pulsed input waveform.

FIG. 8 depicts one possible pulsed input waveform.

FIG. 9 depicts one possible pulsed input waveform.

FIG. 10 depicts one possible pulsed input waveform.

FIG. 11 depicts one possible pulsed input waveform.

FIG. 12 depicts one possible pulsed input waveform.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

The Paging Interface Adapter unit is a system which may accept input from different kinds of devices, interpret the input from those devices, and send appropriate messages to personnel monitoring the input devices. Specifically, the system may connect to existing nurse call system devices and send alerts to monitoring personnel based on the inputs received by the nurse call system devices. The alerts may be sent to the monitoring personnel by utilizing pagers, PDA's, cellular phones, and other communication devices. The system may provide a way of interfacing nurse call devices, which utilize disparate output protocols, in a single system that may be configured to alert monitoring personnel in a unified manner regardless of the particular nurse call device used by any particular patient.

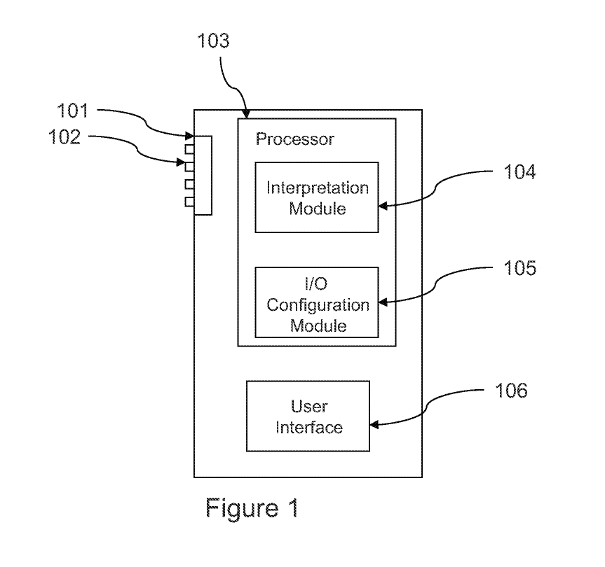

One embodiment of the system for interfacing patient status information with different paging protocols is illustrated in FIG. 1. This embodiment comprises a processor 103, an interpretation module 104, an I/O configuration module 105, a user interface 106, and an input bank 101 further comprising at least one input port 102. The processor 103 may be any microprocessor, microcontroller, processor, controller, central processing unit (CPU) or combination of same that are known in the art. In a preferred embodiment, the processor 103 may be capable of running an operating system such as, for example, any versions of Microsoft Windows, Mac OS X, Unix, Linux, GNU, and the like. In an alternate embodiment, the processor 103 may run a proprietary operating system specifically designed for the system.

The system may comprise an input bank 101, to which the input devices may be electrically connected. The input bank 101 may comprise a plurality of input ports 102. A single input device may connect to a single input port 102. In a preferred embodiment, there may be sixteen input ports 102 per input bank 101. Each unit may be upgradeable to four input banks 101. Therefore, each unit may be upgradeable to sixty-four input ports 102. Additionally, multiple devices may be connected together. In such a configuration, one device may be designated a master and other devices configured as slaves. The devices may be connected together using any communication protocol known in the art, such as, for example, USB, Ethernet, FireWire, BlueTooth, or the like. In a preferred embodiment, the devices may be daisy chained together utilizing the Ethernet port of each device or they may each be connected to and controlled through a LAN. In a preferred embodiment, there may be up to eight slave devices controlled by a single master device. However, the system may be designed to accommodate more than eight slave devices. When multiple units are connected together, each device may comprise a plurality of input banks 101. In a preferred embodiment, with one master device and eight slave devices, there may be as many as five hundred seventy-six input ports 102 spread across a total of thirty-six input banks 101.

Current input devices used in hospitals and other healthcare providing facilities utilize different output signaling protocols. These output signaling protocols are received by the system as input protocols. These input protocols are known in the art and may be different for each manufacturer of the input devices. This system may interface with many different input devices, but in a preferred embodiment the system may interface with nurse call systems. The input ports 102 may be configurable to receive many different types of input protocols. Each input port 102 may be configured independently of the other input ports 102, or blocks of input ports 102 may be configured together. In a preferred embodiment, input ports 102 may be configured in groups of four to receive either voltage, non-voltage, or two different kinds of pulsing signal input protocols. Each input port 102 may be fused to protect the system in case voltage is applied to an input port 102 that has been configured for a non-voltage input protocol. Each input port 102 may be configured to send an alert to different monitoring personnel. Each input port 102 may be configured to send escalating alerts to different monitoring personnel. That is, a first alert may be sent to a primary monitoring contact, a second alert may be sent to a secondary monitoring contact, a third alert may be sent to a tertiary monitoring contact, and so on.

When an input port 102 is configured to receive a voltage signal, the input port may expect the input signal to be held in a low voltage, such as 0 V, state by an external device. The external device may change the input signal to a higher voltage, such as, for example 3V, 5 V, 12 V, 24 V, or the like, to signal a changed condition and initiate an alert. In a preferred embodiment, the input port 102 may be capable of receiving any input voltage level between 0 V and 50 V DC or AC. Alternatively, when the input port 102 is configured to receive a voltage signal, the input port 102 may expect the input signal to be held at a higher voltage and pulled low to signal a changed condition. In either case, the input port 102, may be reset when the voltage level returns to its initial, inactive state. When the input port 102 is reset, the alert may be cleared.

When an input port 102 is configured to receive a non-voltage signal, the input port 102 may expect to receive no voltage level at the input port 102 and the system may internally pull the input port 102 to a voltage higher than 0 V. In such a configuration, the external device connected to the input port 102 provides no voltage signal to the input port 102, but allows the input port 102 to float when the connected input is in an inactive state. When the external device connected to the input port 102 changes conditions, in order to initiate an alert, the input signal will no longer float. When the input in such a configuration is activated, the input device may pull the signal connected to the input port 102 to a low voltage signal, such as, for example 0 V. The input port 102, may be reset when the input signal returns to its initial, inactive state. When the input port 102 is reset to its inactive state, the alert may be cleared.

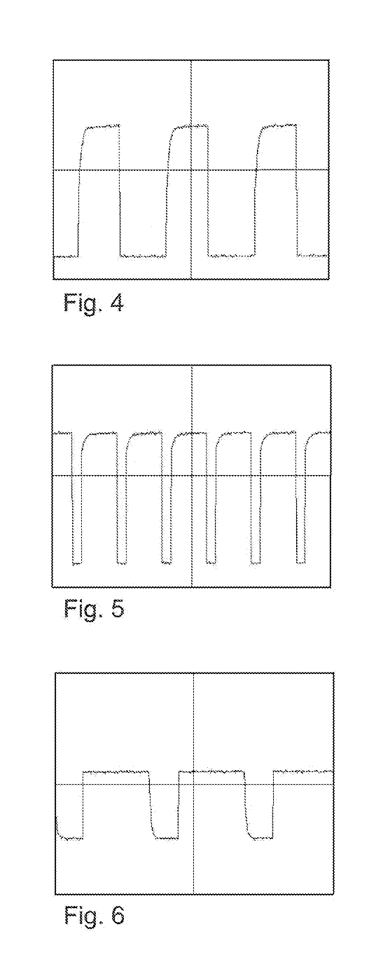

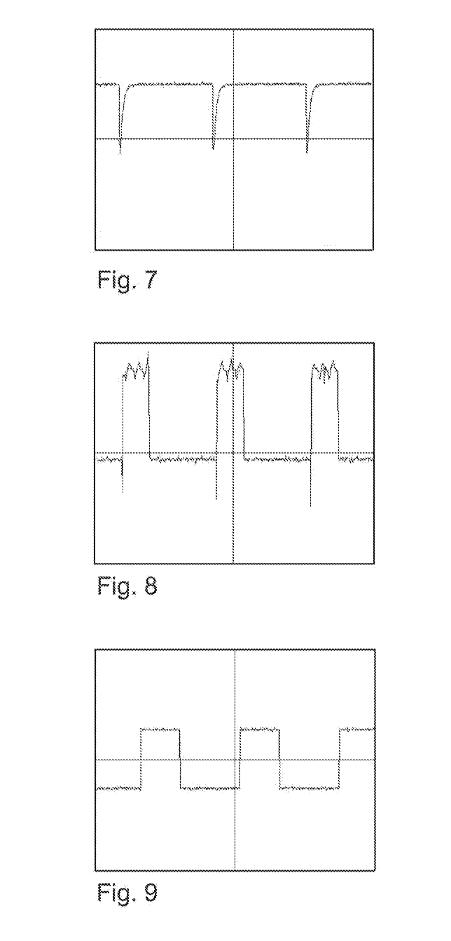

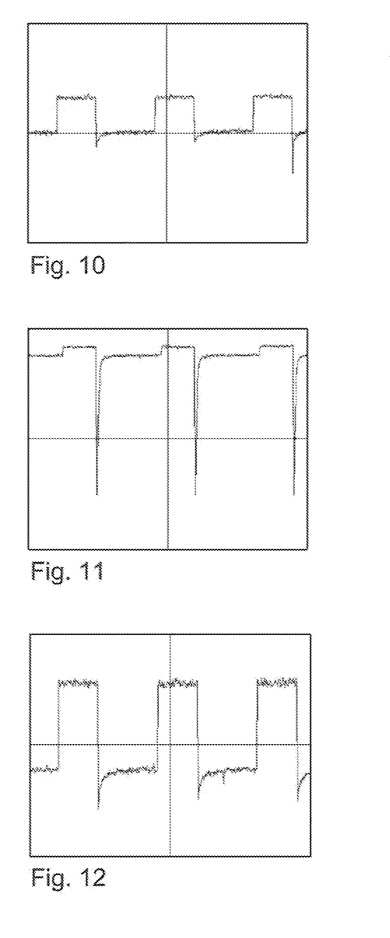

When an input port is configured to receive a pulsing signal, the input port 102 may expect to receive a signal that pulses from a low voltage state to a higher voltage state or from a higher voltage state to a low voltage state. In a preferred embodiment, the input device may transmit a signal that pulses between 0 V and 24 V, but the pulses may range anywhere between 0 V and 50 V. A fast pulsing signal may maintain a high voltage state for 500 ms before transitioning to a low voltage state. A slow pulsing signal may maintain a high voltage state for 1000 ms before transitioning to a low voltage state. Signals may pulse in different time intervals that are known in the art. Examples of pulsed wave forms, which may be detected and trigger alerts, are shown in FIGS. 4-12.

The input ports 102 may be configured through software, hardware, firmware, or any combination of these. In cases where the input ports 102 may be configured entirely through software, each input port 102 may be capable of receiving input signals in any of the described formats. The user simply connects external devices to the desired input ports 102 and then utilizes a user interface 106 to properly associate each physical input port 102 to the input protocol that will be provided to the input port 102. In cases where input ports 102 may be configured by modifying hardware, modular cards may be removed or replaced in the system to facilitate connection of different input protocols to different input ports 102. Alternatively, jumpers, switches, or the like may be configured in the system to allow an input port 102 to accept a particular input protocol.

Each input protocol may be used by an external medical device that can be monitored by this system. The user may configure the input ports 102 using the I/O configuration module 105. The user may set the parameters of the I/O configuration module 105 by selecting from a menu of known devices. The characteristics of the input protocols associated with these known devices are preprogrammed into the system. When the user configures the system by associating an input port 102 with the device, or input protocol, that is connected to the particular port, the system may reference information stored in memory to determine the input data carried by the input protocol to the input port 102.

Parameters may also be supplied to the I/O configuration module 105 to determine the output protocol to be utilized when configuring the output signal. Each input port 102 may be associated with a particular output protocol. Alternatively, each medical personnel or device to which the system information may be sent may be associated with an output protocol. Therefore, the system may decide the output protocol to employ based upon the input port 102 receiving the data, the medical personnel receiving the information, or some other parameter. The parameters of the I/O configuration module 105 may be password protected.

Upon initial installation, the user may need to configure the system in order to associate each input port 102 with the appropriate input protocol. The unit may be programmable by the user, using a user interface 106 utilizing a web browser program, such as, for example, Microsoft Explorer, Mozilla Firefox, Apple Safari, Google Chrome, or the like, or through a user interface 106 program designed specifically for the system. Both methods may be easily implemented by those skilled in the art. In configurations in which it may be desirable to access the system over a network, each unit may have its own Internet Protocol (IP) address. To program a system configured in this way, the user may enter the IP address of the desired system in the user interface 106. The user interface 106 may require a password and all data may be password protected. The system may be programmed from a stand alone personal computer (PC), which may be connected to the system by a communications protocol known in the art, such as, for example, Ethernet or the like. Additionally, the system may be programmed over a local area network (LAN) or over the internet.

The input data provided to the system by each device may be formatted in different input protocols. One advantage of this inventive device is that the system may be preprogrammed with the input protocols of many different input devices. There is no need for the user to connect a device to the system and then teach the system how to respond to the various input signals from the device. The user may simply tell the system what devices are connected to specific input ports 102 and the system will then automatically respond appropriately to the input signals received on those input ports 102. The user may still be able to configure the response of the system and customize the response to input signals.

The system may be preprogrammed to respond appropriately to input data received by ENGINEERED ELECTRONICS, HERITAGE MEDCALL, AIPHONE, CORNELL, and TEKTONE brand nurse call system devices. The system may be preprogrammed with waveforms from the various input devices supported by the system.

The system may comprise at least one processor 103. In a preferred embodiment, the processor may operate at 58.98 MHz. However, the processor may operate at any clock speed known in the art. The processor 103 may operate at any voltage levels known in the art. In a preferred embodiment, the processor 103 may operate with a 1.8 V core and either 3.3 V or 1.8 V I/O. There may be an Ethernet controller built in to the processor. In a preferred embodiment, the Ethernet controller may be 10Base-T. The system may also comprise SRAM, Flash memory, memory for data storage, and serial ports. These components may be, but do not need to be, integrated with the processor 103. In addition to Ethernet connections, the system may utilize ports for RS232, USB, Firewire, Bluetooth, and other communication protocols known in the art.

The interpretation module 104 may be implemented in hardware, software, firmware, or a combination of any of these. In a preferred embodiment, the interpretation module 104 may receive signals from the input ports 102 and determine what information is carried by the input data. The input data may be in the form of a proprietary or non-proprietary input protocol. The interpretation module 104 may use information provided by the user to configure the input ports 102 to determine the input protocol used by the devices connected to each input port 102. The interpretation module 104 may then compare the input data at each port to known signals for the appropriate protocol. This comparison may result in setting an alert for a particular input port 102 which may generate an output signal. Also, this comparison may result in resetting the particular input port 102. The input data may provide medical status, such as, for example, room status, bed call status, bath call status, emergency call status, or the like to the system.

An output signal may be generated by the system. The output system may alert a healthcare provider or other person to the status of one or more input devices. The output signal may be used to send a message, such as, for example, a page, email, telephone call, text, instant message, or the like to a person or device monitoring the system. The output signal may be used to control an audible or visual alarm such as a piezo buzzer, chime, LED, or the like. Additionally, the output signal may cause a message or notification to be displayed on a user interface 106.

In systems in which the output signal is used to generate a page that may be received by a pager, the system may configure output data in an output protocol which is appropriate to the paging system utilized by the pager. SCOPE, COMP2, MOTOROLA TAP V1.8, WAVEWARE, and other preconfigured output protocols known in the art may be supported. The system may be configured to select which output protocol should be utilized. One output protocol may be selected for all signals, or the output protocol may be configured separately for messages resulting from separate input ports 102. Additionally, the output protocol may be determined based on the personnel who will receive the message. The output data, configured in the appropriate output protocol, may be sent to a transcoder that will reformat the data into the POCSAG format and transmit it to the appropriate pagers associated with the system.

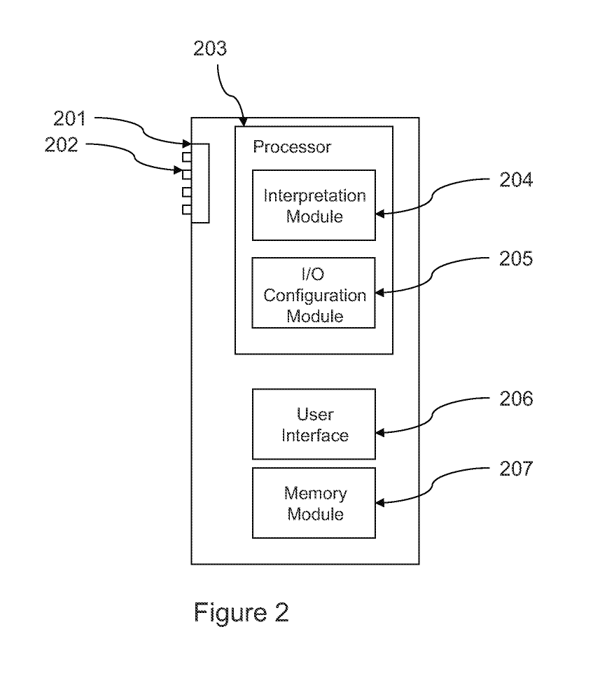

Turning to FIG. 2, the system is depicted with a memory module 207, which may store a log of the medical status information. The memory module 207 may be implemented with a removal storage medium, such as, for example a flash drive, an SD card, a compact flash card, a USB drive, or the like. Additionally, the memory module 207 may be implemented with non-removable storage medium. The memory module 207 may be read-only so that when medical status is provided to the memory module 207 it cannot be altered. Access to information generated by the report module 309 may be password restricted. Also, access to configure the contents of the reports may be password restricted. The memory module 207 may store medical status as well as time stamps and a log of events that have occurred, such as, for example, when the memory module 207 was last accessed, when the memory module 207 was last cleared, when an input port 102 was cleared, or the like. The memory module 207 may also store input port 102 programming information and database information, which may be used to configure the system. This information may be password protected. In a preferred embodiment, the memory module may comprise a 1 GB removable SD card. However, other storage media known in the art may also be used.

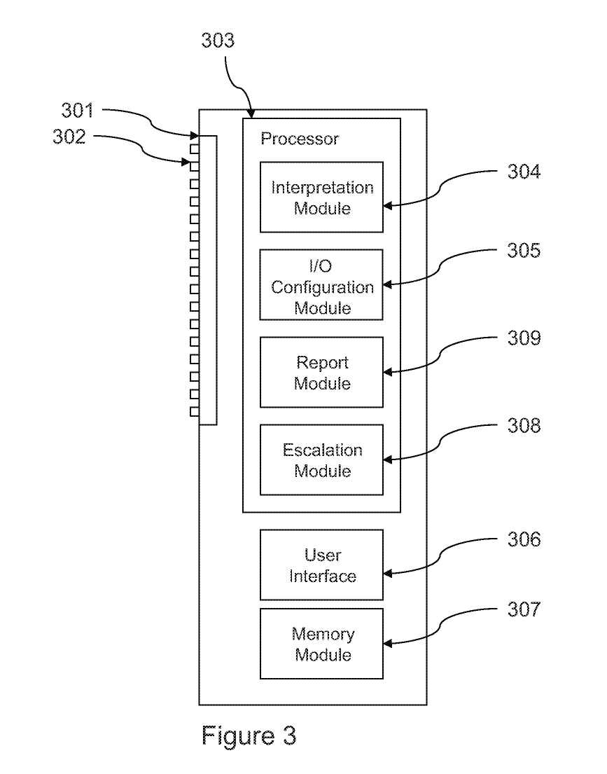

FIG. 3 shows a depiction of the system with a report module 309 and an escalation module 308. The report module 309 may be utilized to generate reports for the user. The details of the contents of the reports may be configured by the user. The user may utilize the user interface 306 to select which information should be included in the report. The report module 309 may access the memory module 307 to obtain information to include in the report. The report may be displayed to the user interface 306 or may be formatted and stored to the memory module 307 as a file.

The escalation module 308 as shown in FIG. 3 is implemented in the processor. However, the escalation module 308 may be implemented in software, hardware, firmware, or any combination of these. The escalation module 308 may monitor the medical status data and generate signals to healthcare workers based on the medical status data. For example, if the medical status data indicates that a bed alarm has been activated, the escalation module 308 may generate an escalation signal, which may cause an alert to be sent to a healthcare worker at some time interval after the alarm was initially activated if an acknowledgment signal is not received within the response time. If the alarm condition is not cleared within a second alarm period of time, second response time, the escalation module 308 may generate another escalation signal, which may cause another alert to be sent to a healthcare worker. In a preferred embodiment, the response time interval may be configured from two (2) minutes to one hundred twenty (120) minutes. The escalation module 308 may generate any number of escalation signals, which may cause any number of alerts to be sent to any number of healthcare workers. However, in a preferred embodiment, the escalation module 308 may implement three levels of alerts. When an acknowledgement signal is received, the escalation module 308 may discontinue sending escalation signals associated with the particular input port 102. The acknowledgement signal may be received by the input port 102 and may comprise a signal returning to its pre-activation state or a uniquely configured signal indicating that the input device connected to the input port 102 has been reset.

The system may be connected to a LAN and monitored remotely by utilizing an IP address that may be assigned to the system. Additionally, a public IP address may be assigned to the system, which may enable the system to be monitored over the Internet.

When the system receives data at the input port 102, the interpretation module 304 may process the data to determine if an alert should be sent to the healthcare provider monitoring the system. The system may be configured to send alerts only when certain input data is received. Additionally, the user may be able to program the system to select what input data should trigger alerts. The system may be configured to send an alert notifying monitoring personnel that the system is healthy and functioning as expected.

The system may be configured to support shifts. When the system is configured to support shifts, different pagers will be sent status information based on what shift is currently responsible for responding to patients.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A system for interfacing patient status information with different messaging protocols comprising:
an input bank further comprising at least one input port capable of receiving input data formatted in one of at least two different input protocols;
an interpretation module wherein said input data is received by said interpretation module and translated into medical status;
and an I/O configuration module;
a user interface wherein said user interface selects a plurality of parameters of said I/O configuration module; and
an output signal wherein said medical status is transmitted as said output signal in an output protocol determined by said plurality of parameters of said I/O configuration module.

2. The system of claim 1 wherein said system further comprises a memory module wherein said memory module is capable of storing a log of said medical status, wherein said log may be read or deleted but may not be modified.

3. The system of claim 1, wherein said system further comprises a report module wherein said user interface is capable of requesting a report from said report module wherein said report is capable of containing said medical status and wherein said report is generated only if a user provides a password.

4. The system of claim 1, wherein said system further comprises an escalation module capable of receiving an acknowledgment signal, wherein said escalation module monitors said input data and generates an escalation signal when said acknowledgment signal is not received within a response time.

5. The system of claim 1, wherein said input bank further comprises at least sixteen input ports capable of receiving input data formatted in one of at least two different input protocols.

6. The system of claim 1, wherein said input port is capable of receiving input data formatted in one of at least four different input protocols.

7. The system of claim 1, wherein said input port is capable of receiving input data formatted in one of at least seven different input protocols.

8. The system of claim 1, wherein said output protocol may be selected from four preconfigured output protocols by setting said plurality of parameters of said I/O configuration module.

9. The system of claim 1, wherein said user interface may be accessed remotely by utilizing an IP address.

10. The system of claim 1, wherein said user interface may be accessed remotely by utilizing a public IP address.

11. A system for interfacing patient status information with different messaging protocols comprising:
an input bank further comprising at least one input port capable of receiving input data formatted in one of at least two different input protocols;
an interpretation module wherein said input data is received by said interpretation module and translated into medical status;
an I/O configuration module;
a user interface wherein said user interface selects a plurality of parameters of said I/O configuration module, and wherein said user interface may be accessed remotely by utilizing an IP address;
an output signal wherein said medical status is transmitted as said output signal in an output protocol selected from four preconfigured output protocols by setting said plurality of parameters of said I/O configuration module; and
a memory module wherein said memory module is capable of storing a log of said medical status, wherein said log may be read or deleted but may not be modified.

12. The system of claim 11, wherein said system further comprises a report module wherein said user interface is capable of requesting a report from said report module wherein said report is capable of containing said medical status and wherein said report is generated only if a user provides a password.

13. The system of claim 11, wherein said system further comprises an escalation module capable of receiving an acknowledgment signal, wherein said escalation module monitors said input data and generates an escalation signal when said acknowledgment signal is not received within a response time.

14. The system of claim 11, wherein said input bank further comprises at least sixteen input ports capable of receiving input data formatted in one of at least two different input protocols.

15. The system of claim 11, wherein said input port is capable of receiving input data formatted in one of at least four different input protocols.

16. The system of claim 11, wherein said input port is capable of receiving input data formatted in one of at least seven different input protocols.

17. The system of claim 11, wherein said user interface may be accessed remotely by utilizing a public IP address.

18. A system for interfacing patient status information with different messaging protocols comprising:
an input bank further comprising at least sixteen input ports capable of receiving input data formatted in one of at least four different input protocols;
an interpretation module, an escalation module capable of receiving an acknowledgment signal, and a report module, wherein said input data is received by said interpretation module and translated into medical status, and wherein said escalation module monitors said input data and generates an escalation signal when said acknowledgment signal is not received within a response time;
an I/O configuration module;
a user interface wherein said user interface selects a plurality of parameters of said I/O configuration module, wherein said user interface may be accessed remotely by utilizing an IP address, and wherein said user interface is capable of requesting a report from said report module wherein said report is capable of containing said medical status and wherein said report is generated only if a user provides a password;
an output signal wherein said medical status is transmitted as said output signal in an output protocol selected from four preconfigured output protocols by setting said plurality of parameters of said I/O configuration module; and
a memory module wherein said memory module is capable of storing a log of said medical status, wherein said log may be read or deleted but may not be modified.

19. The system of claim 18, wherein said input port is capable of receiving input data formatted in one of at least seven different input protocols.

20. The system of claim 18, wherein said user interface may be accessed remotely by utilizing a public IP address.
